(19) United States
(12) Patent Application Publication
(10) Pub. No.: US 2014/0151154 A1
(43) Pub. Date: Jun. 5, 2014

(54) Multi-purpose hunting platform assembly

(71) Applicant: Peter Sama, II, Clayton, CA (US)

(72) Inventor: Peter Sama, II, Clayton, CA (US)

(21) Appl. No.: 13/987,526

(22) Filed: Aug. 2, 2013

Related U.S. Application Data
(60) Provisional application No. 61/679,067, filed on Aug. 2, 2012.

(51) Int. Cl. A01M 31/02

(52) U.S. Cl. CPC A01M 31/025; A01M 31/02
USPC 182/223

(57) ABSTRACT

The present disclosure relates to hunting, law enforcement, and military systems and the like. The present disclosure includes a hunting apparatus comprising a base; a frame coupled to the base. The base is rotatable around said base and the base provides concealment for a user therein.

### PRIORITY

This application claims priority to provisional application 61/679067 filed Aug. 2, 2012, incorporated herein by reference.

### FIELD

The present disclosure relates to hunting, law enforcement, and military systems and the like.

### BACKGROUND

Hunting often involves remaining still in the same body position for long periods of time. Whether in a seated or standing position, lack of movement for an extended amount of time may cause discomfort to the hunter, particularly the hunter's back and legs. Military and law enforcement personnel have experienced similar discomfort while engaged in tactical operations.

The prone position offers a more comfortable shooting position, however, there are a number of problems associated with lying on the ground. Insects, snakes, very cold ground, water, and mud, may make the ground very uncomfortable and impractical in many environments.

Prior art hunting blinds also have limitations, particularly for young and senior hunters. For example, ladder and climbing tree stands may be dangerous because users may fall out of them and get seriously injured. In addition, ladder and tripod stands are often difficult to set up and transport requiring hunters to buy several stands and place them at numerous locations. Lastly, standard ground blinds (e.g., camouflage tents) are difficult to set up and transport and typically work best on flat terrain.

Prior art hunting blinds, stands, and other similar systems do not provide additional functions other than the specific purpose they are designed to perform. Particularly, these systems may not be used to carry equipment or transport game captured during a hunting exhibition.

Furthermore, prior art hunting systems are designed for single purpose hunting. Therefore, these systems are unable to adapt to a variety of desired game types. For example, deer hunting tree stands may not be used effectively for duck or goose hunting and blinds for bird hunting may not be used effectively for deer hunting or similar types of game. Accordingly, the present disclosure addresses such a need.

### BRIEF SUMMARY OF THE INVENTION

The present disclosure includes a platform assembly which allows a user to lie in an elevated, prone shooting position. The shooting platform is attached to a base that allows the platform to be both rotated horizontally and tilted vertically. These rotation and tilt adjustments enable the user to easily change the configuration of the invention to accommodate a variety of desired aiming locations. Users are able to rotate the platform assembly by using their legs or by using an attachment on the platform's base and employing their arms. In some embodiments, the rotation mechanism may also be motorized.

The present disclosure has an adjustable rifle rest that may also be extended or contracted horizontally and vertically. The base of the platform assembly has adjustable legs that may also be extended or contracted to allow the platform assembly to remain stable and level in uneven terrain. The adjustable legs also allow the platform assembly's vertical tilt angle to be adjusted.

In some embodiments, the shooting platform frame of the present disclosure is covered in a removable fabric cover. The cover may have a variety of camouflage patterns. Additionally, a camouflage top cover/canopy of several lengths may be attached to the frame to provide both shelter and concealment.

The platform assembly may also be easily adjusted into several transportation configurations. The platform assembly may have backpack straps attached to the fabric cover that allow the assembly to be converted into a backpack-like, carrying configuration. Wheels may also be attached to the platform assembly to allow the assembly to be pulled by a person or attached to a vehicle. When configured in this manner, the platform assembly has the ability to transport game or equipment on top of the shooting platform. Advantageously, the platform assembly's frame may also be mounted on top of an elevated tripod or quad-pod platform and rotated 360 degrees in either direction.

The platform assembly is also designed to be adapted and accept an attachment that connects to the frame and allows the user to operate a firearm from a seated position. The platform assembly allows a user to lie on his/her back with his/her feet on the ground. Furthermore, a chest strap allows the user to rotate and lock the backrest into an inclined position. A release mechanism allows the locked backrest to be unlocked and rotated back into a reclined position.

A ballistic shield attachment may also be connected to the front of the platform assembly to protect law enforcement or military personnel from incoming gunfire.

### BRIEF DESCRIPTION OF THE DRAWINGS

FIG. 1 is a side view illustration of the platform assembly without the fabric cover showing various components of the assembly according to some embodiments of the present disclosure.

FIG. 2 is an illustration of the frame without the fabric cover showing the various components of the disassembled assembly's frame according to some embodiments of the present disclosure.

FIG. 3 is an illustration of the platform assembly base showing the rotation bearing attached to the base cross rails according to some embodiments of the present disclosure.

FIG. 4 is an illustration of the platform assembly's base with the interior leg extensions removed according to some embodiments of the present disclosure.

FIG. 5 is an illustration of the platform assembly's braking mechanism that enables the user to create friction on the rotation bearing to reduce or stop the platform assembly's horizontal rotation according to some embodiments of the present disclosure.

FIG. 6 is an illustration of the braking mechanism attached to the frame and aligned with the platform assembly's rotation bearing according to some embodiments of the present disclosure.

FIG. 7 is an illustration of one of the platform assembly's wheel attachments removed from the frame assembly according to some embodiments of the present disclosure.

FIG. 8 is a top view illustration of a partial platform assembly with the wheel attachments inserted and locked into the frame according to some embodiments of the present disclosure.

FIG. 9 is top view illustration showing the fabric covers and rear footrest attached to the frame according to some embodiments of the present disclosure.

FIG. 10 is a top view illustration showing the canopy support frame attached to the fabric cover.

FIG. 11 is a front view illustration which shows the drop-down fabric camouflage that extends from the front fabric frame cover and canopy according to some embodiments of the present disclosure.

FIG. 12 is a top view illustration showing a full-length canopy support frame attached to the fabric cover and footrest.

FIG. 13 is a top view illustration showing the full-length canopy attached to the full-length canopy support frame with an opening to allow the user to gain access to the platform assembly's shooting platform according to some embodiments of the present disclosure.

FIG. 14 is a side view illustration showing backpack straps attached to the platform assembly according to some embodiments of the present disclosure.

FIG. 15 is an illustration showing the seated shooting position attachment in a reclined position connected to the frame assembly according to some embodiments of the present disclosure.

FIG. 16 is an illustration showing the seating attachment in an inclined position connected to the frame assembly according to some embodiments of the present disclosure.

FIG. 17 is an illustration showing the seating attachment in an inclined position connected to the frame assembly according to some embodiments of the present disclosure.

FIG. 18 is an illustration showing the components of a seating attachment according to some embodiments of the present disclosure.

FIG. 19 is an illustration showing a rear-view of the seating attachment in a locked, inclined position according to some embodiments of the present disclosure.

FIG. 20 is an illustration showing the seating attachment in an unlocked, reclined position according to some embodiments of the present disclosure.

FIG. 21 is an illustration of a person using the platform assembly from the prone position with his/her legs utilizing the footpad according to some embodiments of the present disclosure.

FIG. 22 is an illustration of a person using the platform assembly from the prone position with his/her legs positioned on the ground below according to some embodiments of the present disclosure.

FIG. 23 is an illustration of a person in a reclined position with his/her feet on a surface according to some embodiments of the present disclosure.

FIG. 24 is an illustration of a person using the platform assembly with the seated shooting attachment connected to the frame according to some embodiments of the present disclosure.

FIG. 25 is an illustration of the platform assembly's handrail attachment according to some embodiments of the present disclosure.

FIG. 26 is an illustration of the platform assembly's handrail attachment attached to the base according to some embodiments of the present disclosure.

FIG. 27 is an illustration of a user holding onto the handrail attachment to rotate the platform assembly's frame according to some embodiments of the present disclosure.

FIG. 28 is an illustration of an elevated quad-pod without the platform assembly's frame attached thereto according to some embodiments of the present disclosure.

FIG. 29 is an illustration of an elevated quad-pod with the platform assembly's frame attached according to some embodiments of the present disclosure.

FIG. 30 is an illustration of the ballistic shield attachment which connects to the platform assembly's frame according to some embodiments of the present disclosure.

FIG. 31 is an illustration of the ballistic shield attachment connected to the platform assembly's frame according to some embodiments of the present disclosure.

### DETAILED DESCRIPTION

The present disclosure relates to hunting, law enforcement, and military systems and the like. A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. The described techniques may be practiced according to the claims without some or all of these specific details. For the purpose of clarity, technical material that is known in the technical fields related to the embodiments has not been described in detail to avoid unnecessarily obscuring the description.

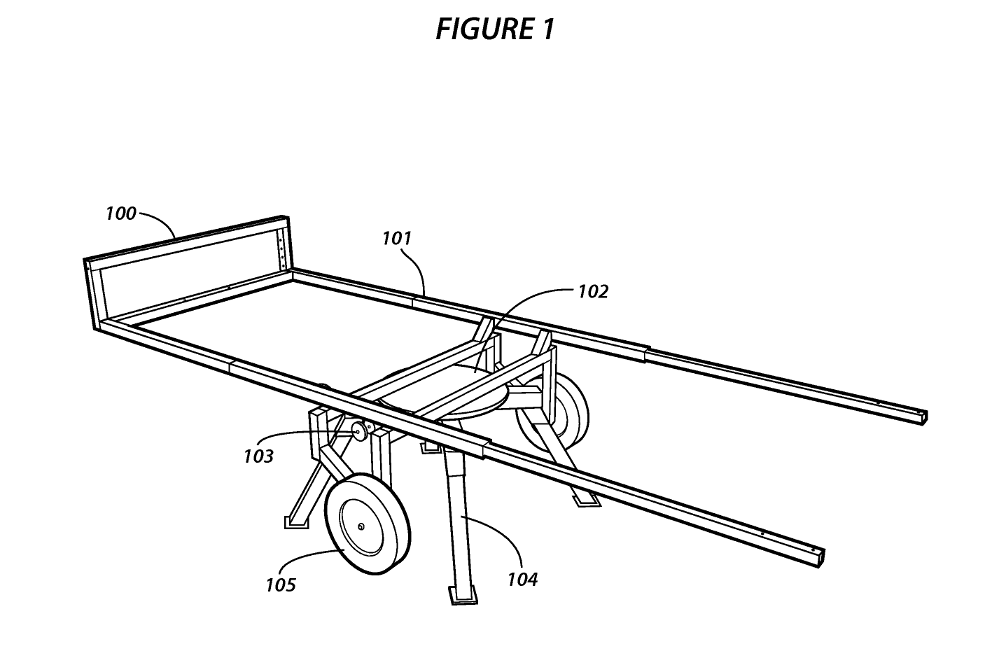

FIG. 1 is a side view illustration of the platform assembly 110 without the fabric cover showing various components of the assembly according to some embodiments of the present disclosure. Platform assembly may comprise a frame 101 coupled upon a base component.

The platform assembly's components illustrated in FIG. 1 include an adjustable gun rest 100, frame 101, bearing assembly 102, adjustable breaking mechanism 103, adjustable legs 104, and detachable wheels 105. It should be appreciated the present disclosure is not limited to the components shown in FIG. 1. As such, more or less components may be attribute d to platform assembly 110 so long as the assembly 110 maintains the functionality described herein.

As will be described in more detail below, frame 101 which when donned with fabric, provides a platform on which a person is able to lay upon. Furthermore, the bearing assembly 102 allows the frame 101 to rotate 360 degrees around the base. Notably, the breaking assembly 103 may be adjustable and may provide friction to the base to decrease the frame's 101 rate of rotation. Lastly, legs 104 may be adjustable so that a user may set the height of the frame 101 from the surface according to the user's preference(s).

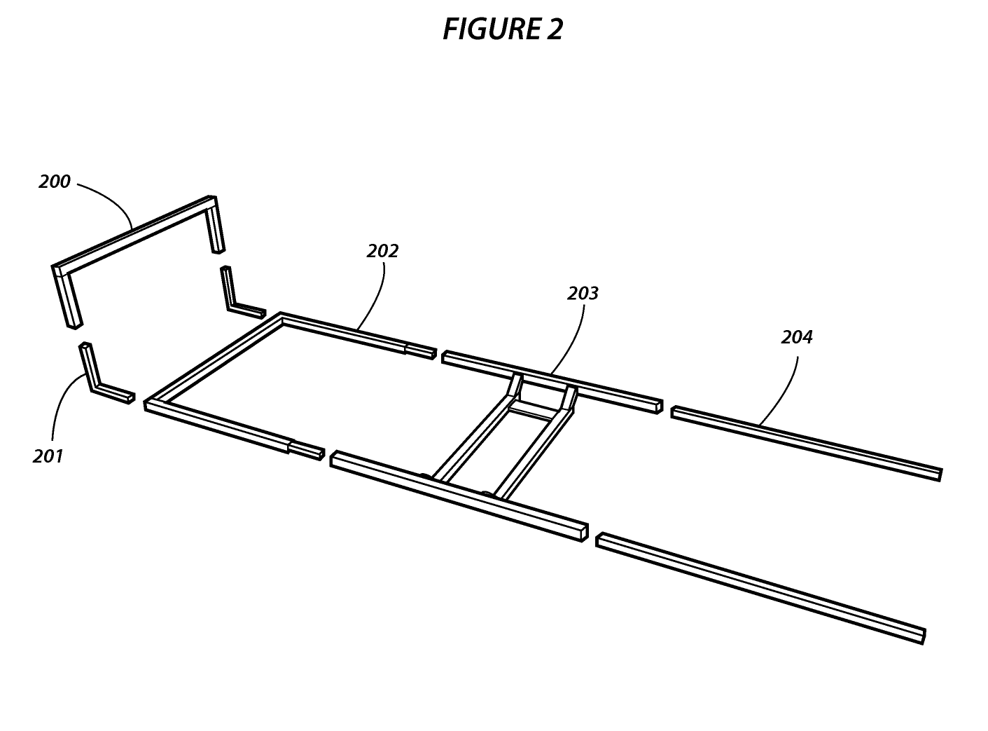

FIG. 2 is an illustration of the frame 101 without the fabric cover showing the various components of the disassembled assembly's frame 101 according to some embodiments of the present disclosure. The frame 101 comprises a gun rest 202 which includes a vertical adjustment bar 201, two vertical adjusters 222, and two horizontal adjusters 223.

The adjuster components 222, 223 operate independently and may be locked into position using a system of holes and spring-loaded push buttons (not shown). In some embodiments, diminishing sizes of tubing allow the vertical rails 224 of the horizontal adjusters 223 to be inserted into the vertical adjusters 222. The same principle allows the horizontal adjusters 223 to be inserted into a system of holes (not shown) into the front frame assembly 225.

In some embodiments, the front frame assembly 225 has inserts of a diminishing size that allows the assembly 225 to connect with the middle frame assembly 226. Both front frame assembly 225 and middle frame assembly 226 may connect using a system of holes and spring-loaded push buttons.

Lastly, a rear frame assembly, 227 comprises two sections of tubing 228 which are insertable into the side rails 229 of the middle frame 226. Advantageously, the tubings 228 are adjustable to various lengths using the series of holes and spring-loaded push buttons.

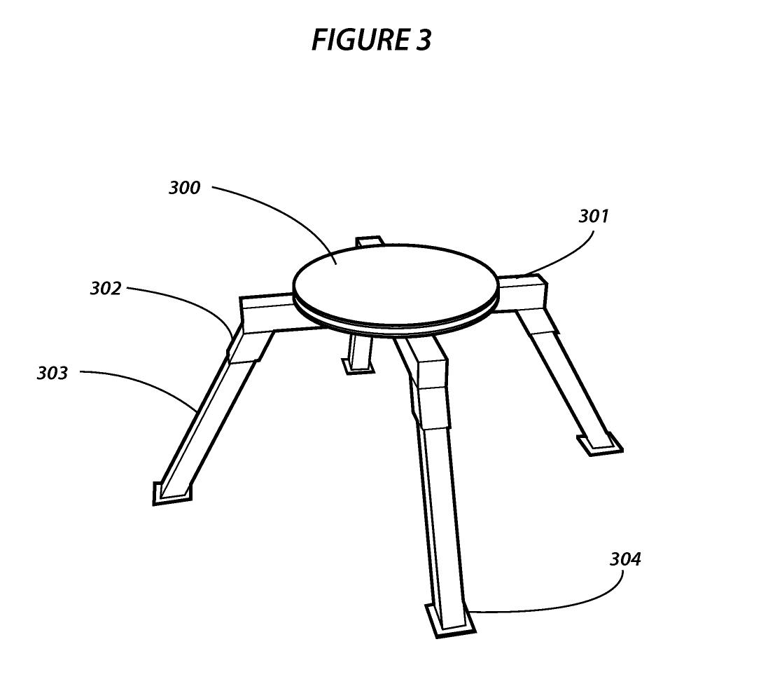

FIG. 3 is an illustration of the platform assembly base 315 showing the rotation bearing attached to the base cross rails according to some embodiments of the present disclosure. When assembled, the middle frame assembly (see FIG. 2) connects to the top of a rotating bearing 302. The bottom of the rotating bearing 302 independently connects to the cross-section of the base 315 thereby enabling the frame to rotate 360 degrees around the base 315. The base 315 further comprises leg sockets 331 each coupled to a single leg extension 332. Base plates 333 may be attached to leg extensions 332 which may allow the platform assembly to achieve stability upon even and some uneven terrain.

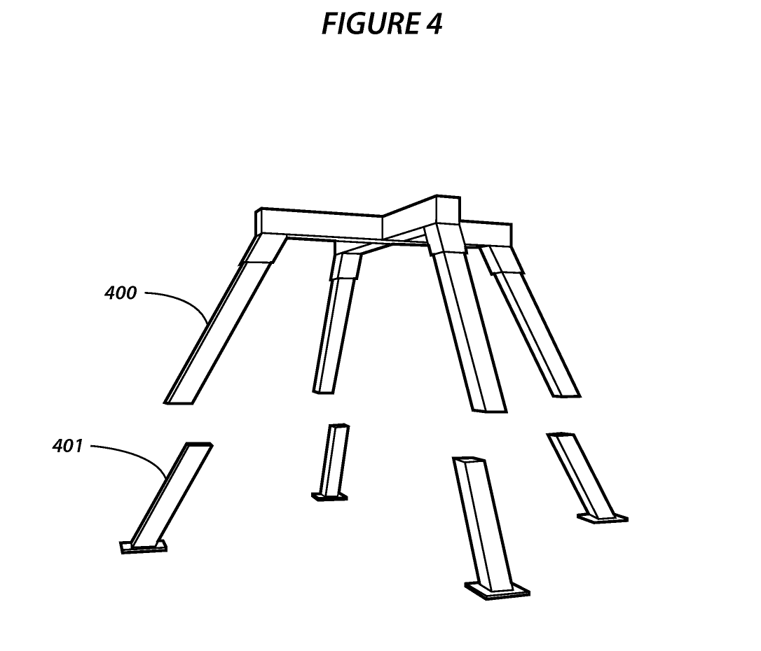

FIG. 4 is an illustration of the platform assembly's base 415 with the interior leg extensions removed according to some embodiments of the present disclosure. In particular, the figure shows that each leg component 432 includes two sub-components—adjustable leg inserts 432a and fixed position legs 432b.

In some embodiments, the adjustable leg inserts 432a may be locked into the fixed position legs 432b at various depths using a series of holes and spring-loaded push buttons (not shown). Because each adjustable leg inserts 432a may be locked at various depths inside a single fixed position leg 432b, the base 415 may be made level on uneven terrain. Additionally the entire platform assembly may be tilted forward or rearward direction through the same method.

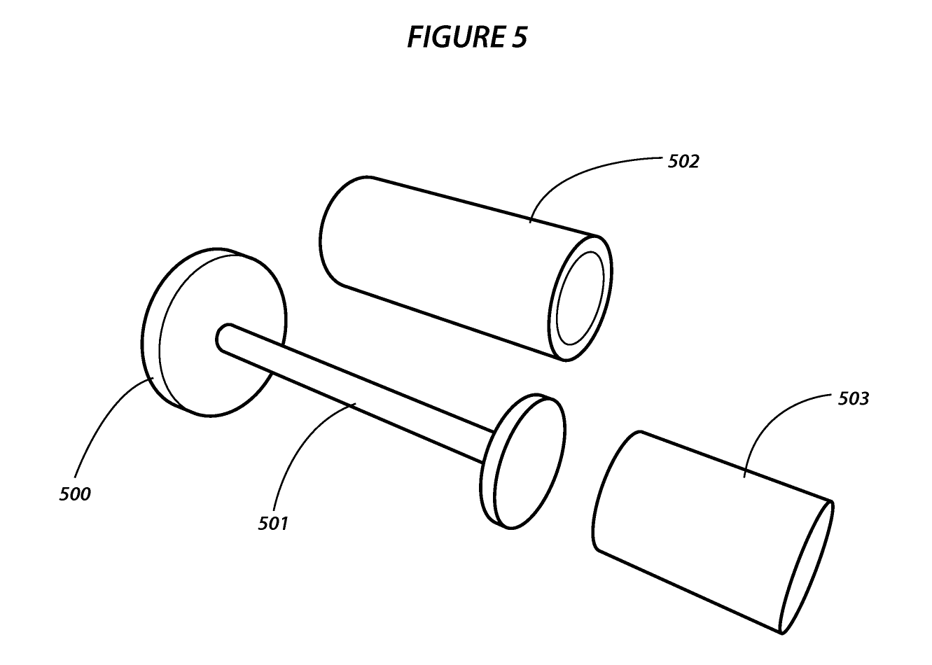

FIG. 5 is an illustration of the platform assembly's braking mechanism 503 that enables the user to create friction on the rotation bearing to reduce or stop the platform assembly's horizontal rotation according to some embodiments of the present disclosure. When the braking assembly 503 is assembled, insert 551 is contained inside a cylindrical tube 552. The degree of insert 551 protruding from the cylindrical tube 552 may be extended or retracted using a spinning knob 553 and threaded assembly 551. Insert 551 may be made from various materials so long as the insert 551 is extendable or retractable. In some embodiments, insert 551 is a molded rubber insert 551.

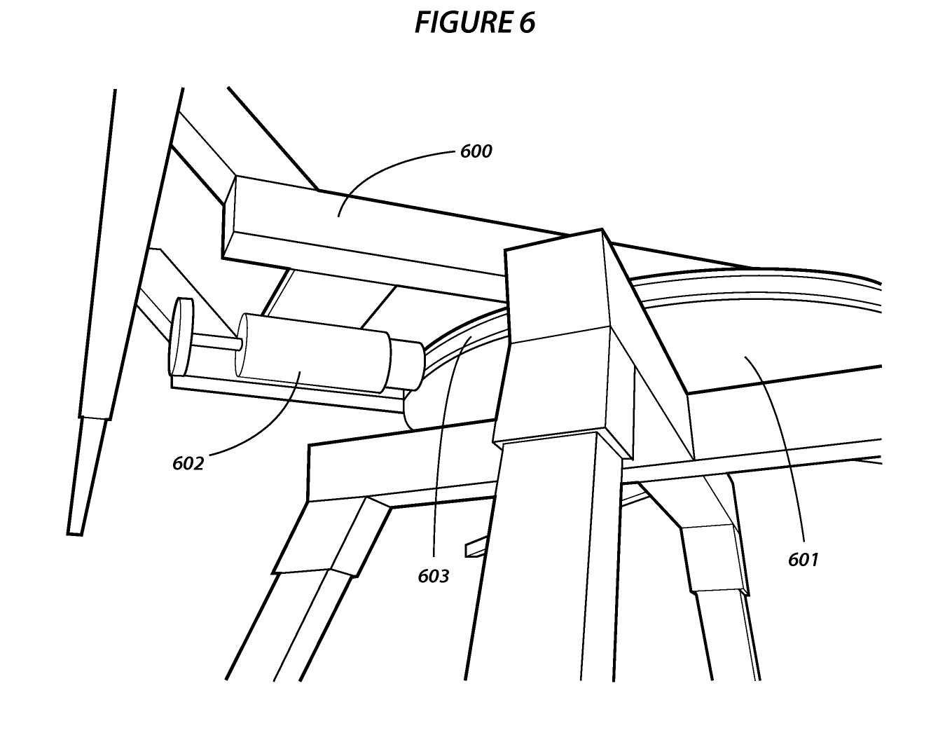

FIG. 6 is an illustration of the braking mechanism 603 attached to the frame and aligned with the platform assembly's rotation bearing according to some embodiments of the present disclosure. FIG. 6 shows the assembled braking mechanism 603 coupled to the middle frame assembly 626.

The position of the braking mechanism 603, when aligned to the side of the bearing 602, creates a friction point 661. The friction caused by the braking mechanism against the bearing causes the rotation of the bearing 602 to decrease requiring more physical force from the user to rotate the frame/shooting platform. The braking mechanism 603 provides more control and precision when rotating and to provide a more stable aiming platform.

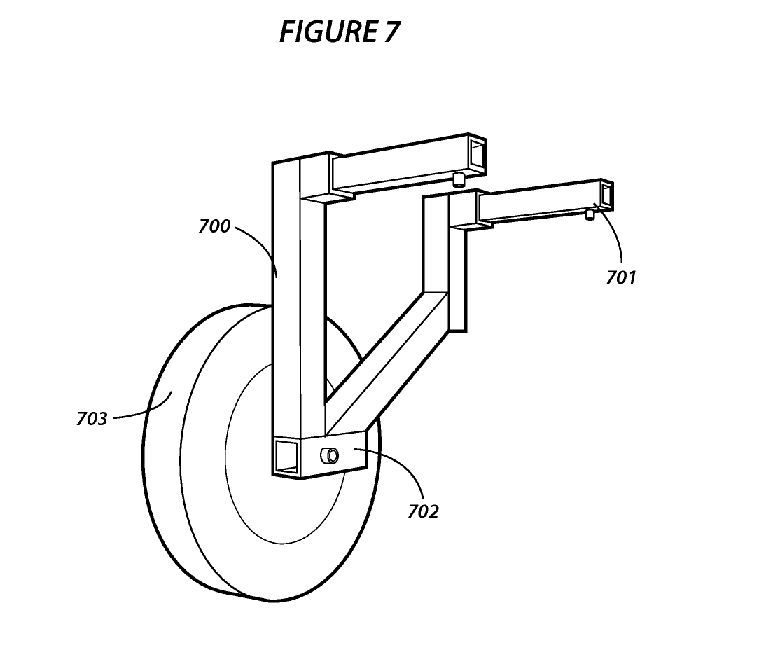

FIG. 7 is an illustration of one of the platform assembly's wheel attachments 720 removed from the frame assembly according to some embodiments of the present disclosure. As shown, one of the platform assembly's wheel attachments 720 comprises the wheel frame 771, frame inserts and spring-loaded push buttons 772, axle 773, and wheel 774.

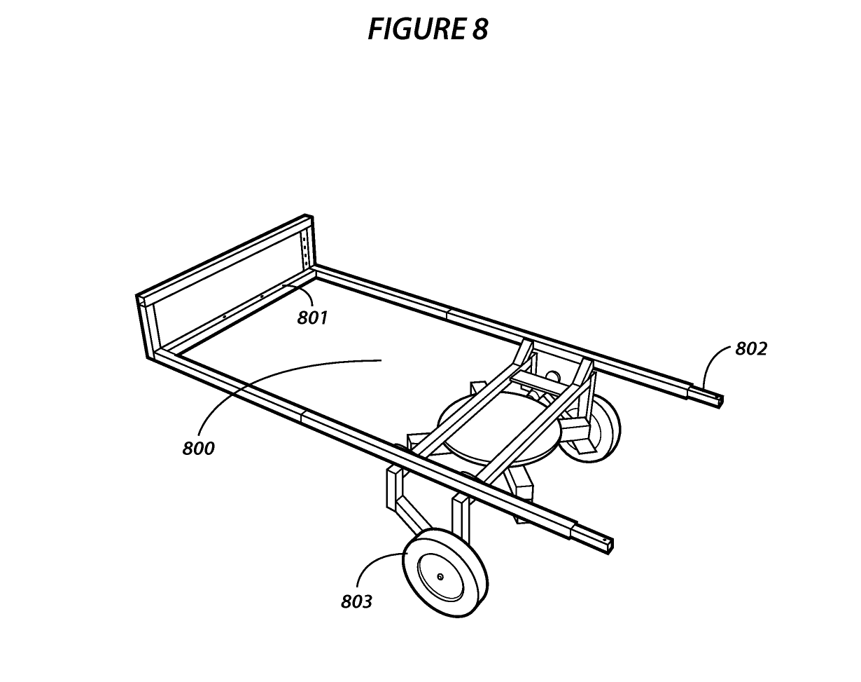

FIG. 8 is a top view illustration of a partial platform assembly with the wheel attachments 874 inserted and locked into the frame according to some embodiments of the present disclosure. Wheel attachments 874 may be inserted into slots (not shown) on the underside of the middle frame assembly 826 and lock in place using the frame inserts and spring loaded push buttons (see FIG. 7).

In some embodiments, the wheel assemblies 874 are positioned higher than the bottom ends of the fixed position leg components and the adjustable leg inserts such that the bottom of the wheels do not contact the surface when the leg extensions are assembled. In some embodiments, the wheels are enabled, the fixed position legs and adjustable leg inserts are removed from the platform assembly.

The front frame assembly has holes drilled through the front bar 881 that enable a manual pulling handle or trailer hitch to be attached. The open area of the frame 802, when covered with fabric, provides an area on which equipment or game may be loaded to facilitate the platform assembly to function as a cart. The rear frame assembly (not shown) may be retracted when the platform assembly is configured as a cart.

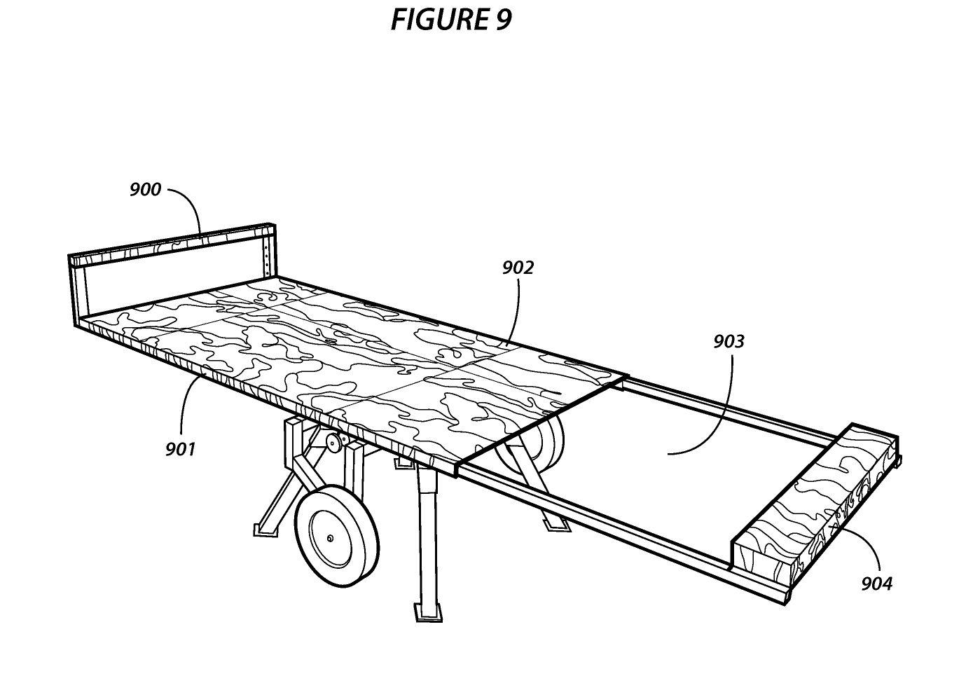

FIG. 9 is top view illustration showing the fabric covers 992 and rear footrest 994 attached to the frame 925 according to some embodiments of the present disclosure. As shown, the fabric coverings comprise a padded gun rest covering 991, front frame assembly covering 992, middle frame assembly covering 993, and padded footrest 994.

A gap 995 is also shown between the middle frame assembly and the foot rest. Gap 995 enables a user, while lying on the shooting platform to place his/her legs on a surface while the user's upper body remains supported by the front and middle frame assembly covers 992, 993.

For example, while the user's feet are positioned on the surface through gap 995, the user is able to maintain a two-handed, prone firing position on the shooting platform. The user may then control and rotate the frame about the base by using their feet and legs as leverage.

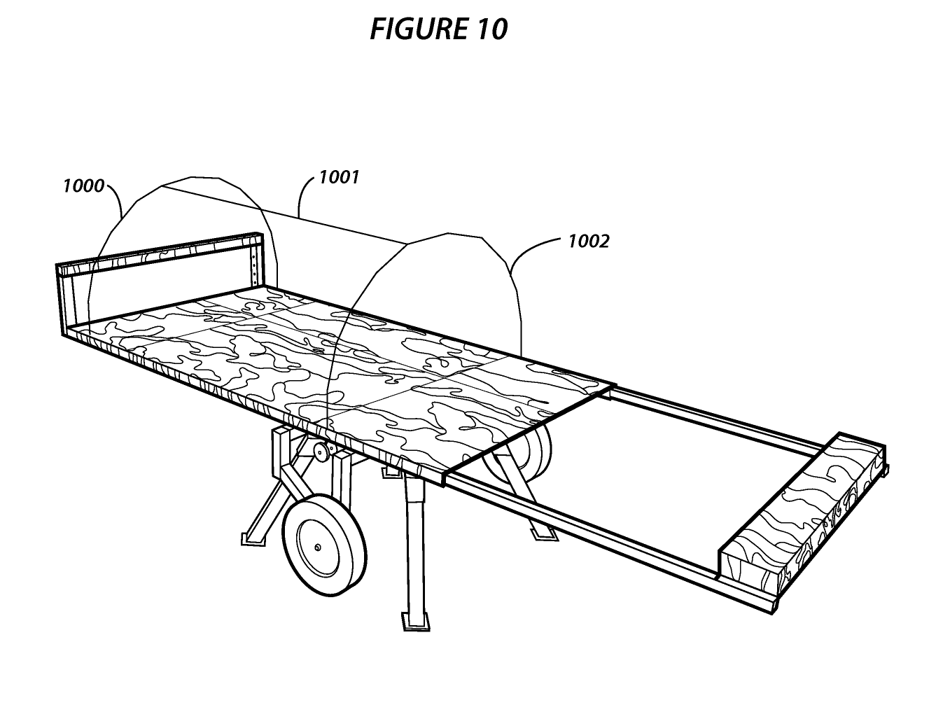

FIG. 10 is a top view illustration showing the canopy support frame attached to the fabric cover. As shown, a frame of flexible, small diameter poles 1000, 1001, 1002 may be attached to frame covers to support a canopy. As will be described in more detail below, the canopy provides enclosure for a user during operation.

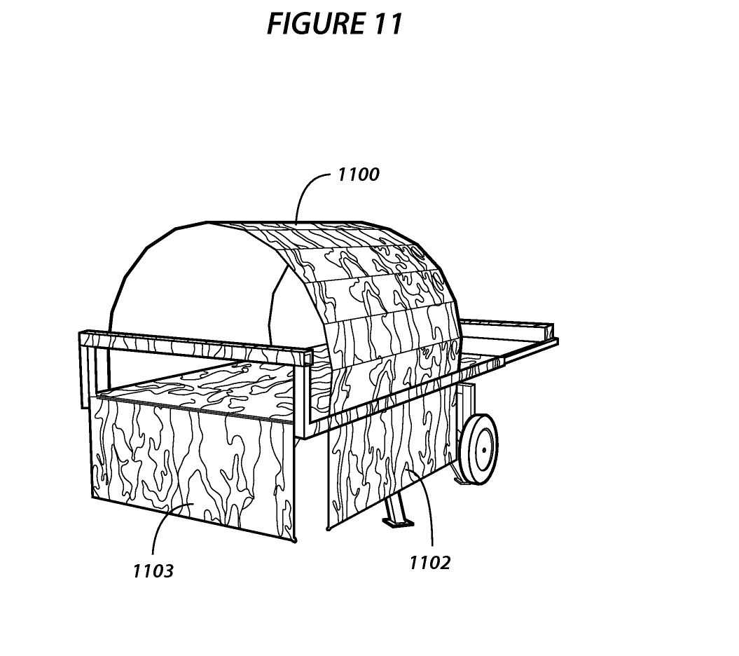

FIG. 11 shows a canopy 1150 that when attached to the canopy frame poles 1000, 1001, 1002, provide both cover from the elements and concealment for the person lying on the shooting platform. The canopy sides 1151, 1152 extend below the frame assembly to provide additional concealment. Additional frontal concealment may be attached to the gun rest 1100 of front frame cover 1153. Windows or mesh may be added to the canopy cover sides to provide the user with additional visibility.

Advantageously, the fabric attachments may contain various colors and camouflage patterns to match the environment of the user. Additionally, the frame 1101 may contain different colors and patterns for the same purpose.

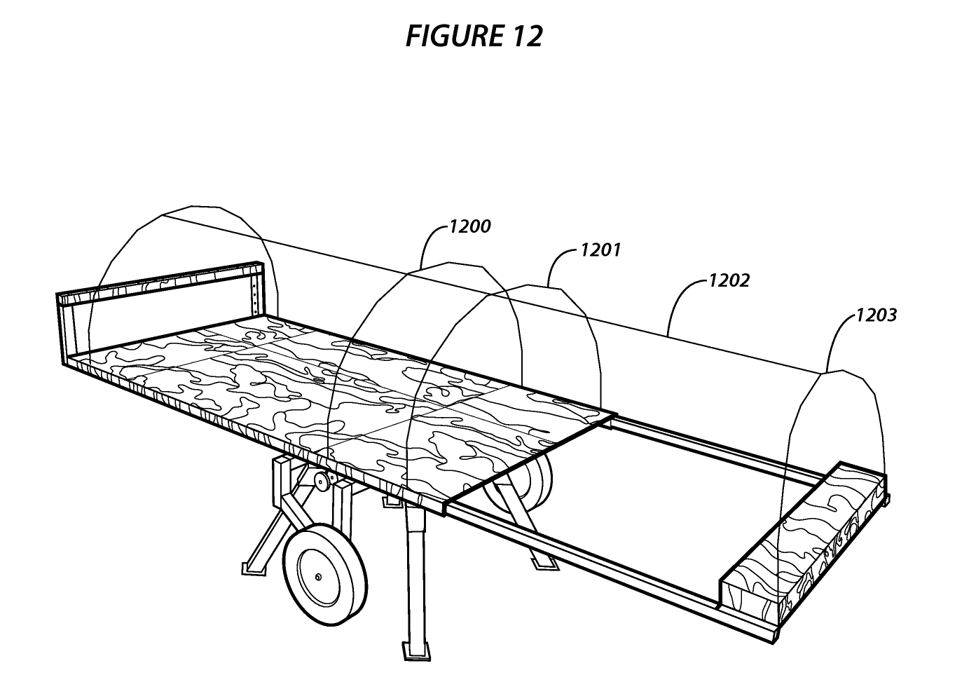

FIG. 12 is a top view illustration showing a full-length canopy support frame attached to the fabric cover and footrest. FIG. 12 shows additional canopy framing 1201 that extends the canopy the full length of the shooting platform 1200, 1201, 1202, 1203. A user may configure the platform assembly to include the full canopy framing to have adequate covering to take a nap or sleep.

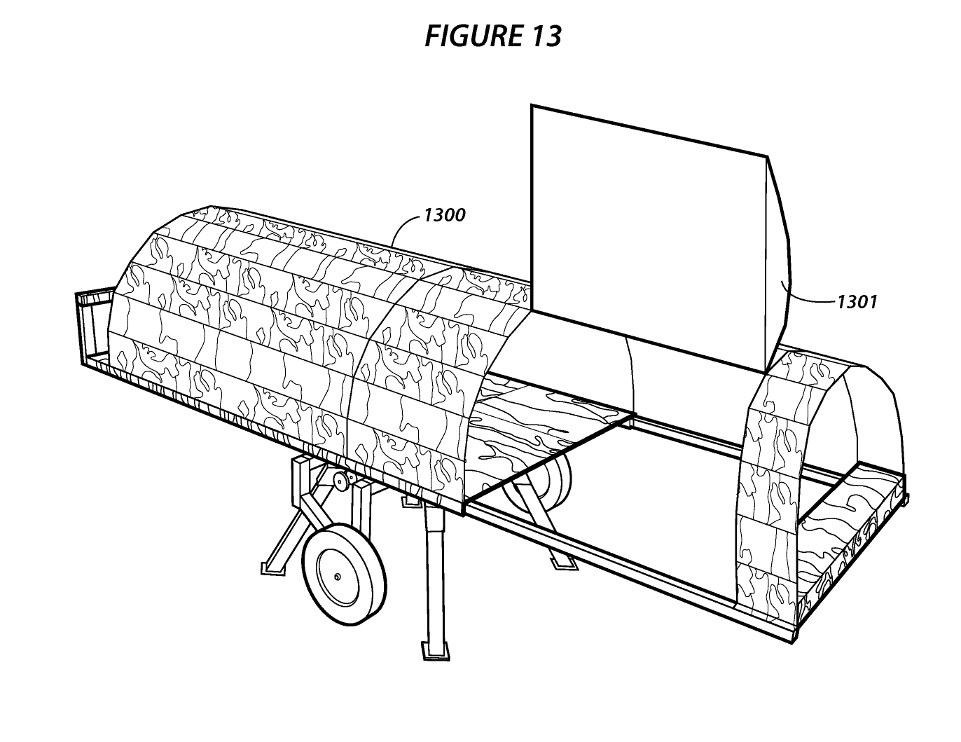

FIG. 13 is a top view illustration showing the full-length canopy 1335 attached to the full-length canopy support frame with an opening 1322 to allow the user to gain access to the platform assembly's shooting platform according to some embodiments of the present disclosure. As shown, an additional fabric canopy component 1321 that extends the length of the shooting platform 1325. A flap entrance 1322 allows the user to gain access to the shooting platform 1325.

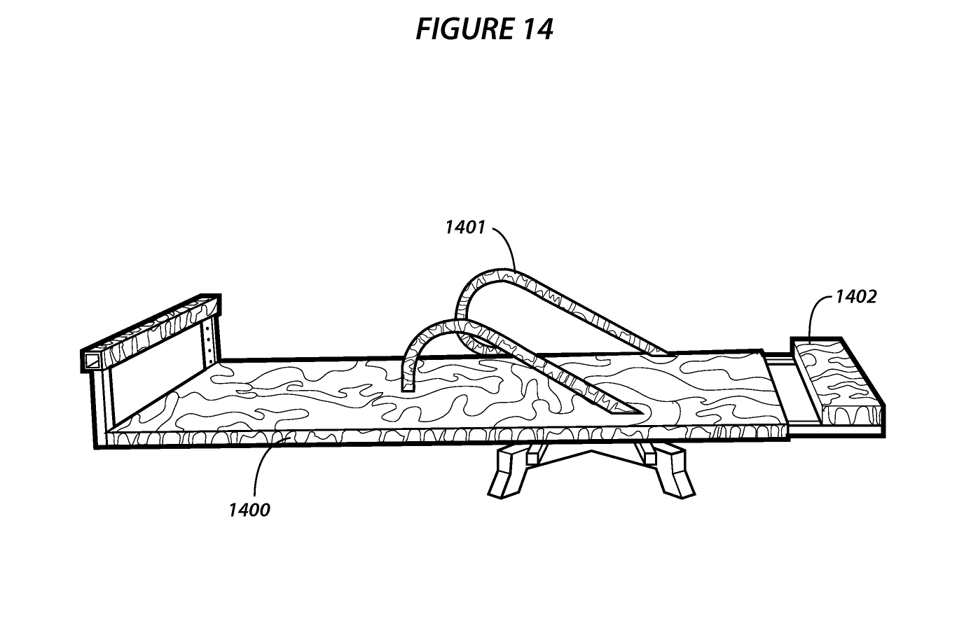

FIG. 14 shows backpack straps 1441 attached to the partial platform assembly 1451. The rear frame assembly is fully retracted and locked into place to allow a user to transport the assembly. For example, if the user is out hunting and wishes to move the platform assembly away from the assembly's current location, the user may remove the fixed position legs and adjustable leg components from the assembly, attach the backstraps 1441 to the frame 1401, and carry the partial platform assembly 1451

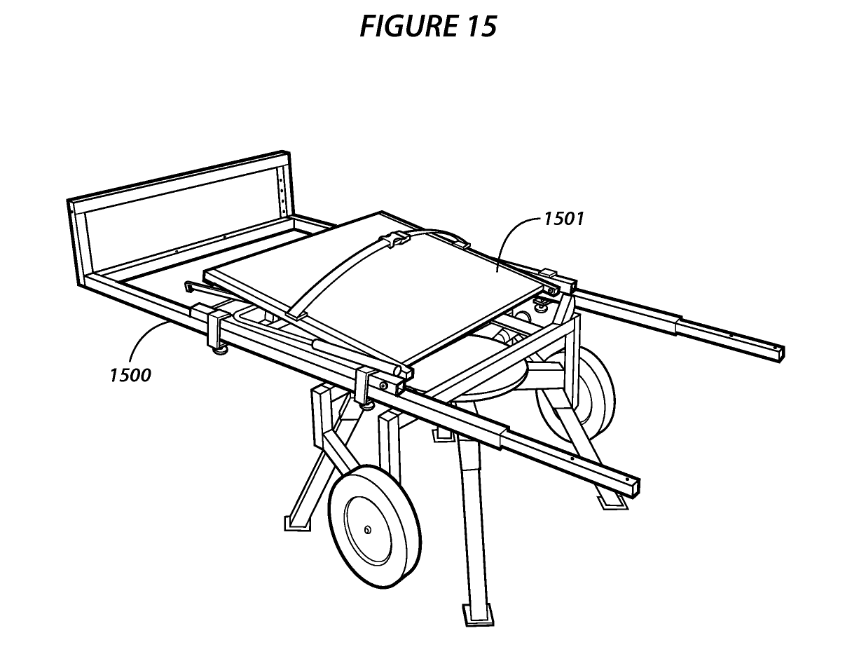

FIG. 15 is an illustration showing the seating attachment 1551 in a reclined position connected to the frame 1501 according to some embodiments of the present disclosure. The platform assembly may be converted from a rotating, prone shooting platform to a rotating, seated shooting platform. FIG. 15 shows a reclining/inclining seating attachment 1551 connected to the platform assembly's frame 1501. The seating attachment 551 is shown in the reclined position.

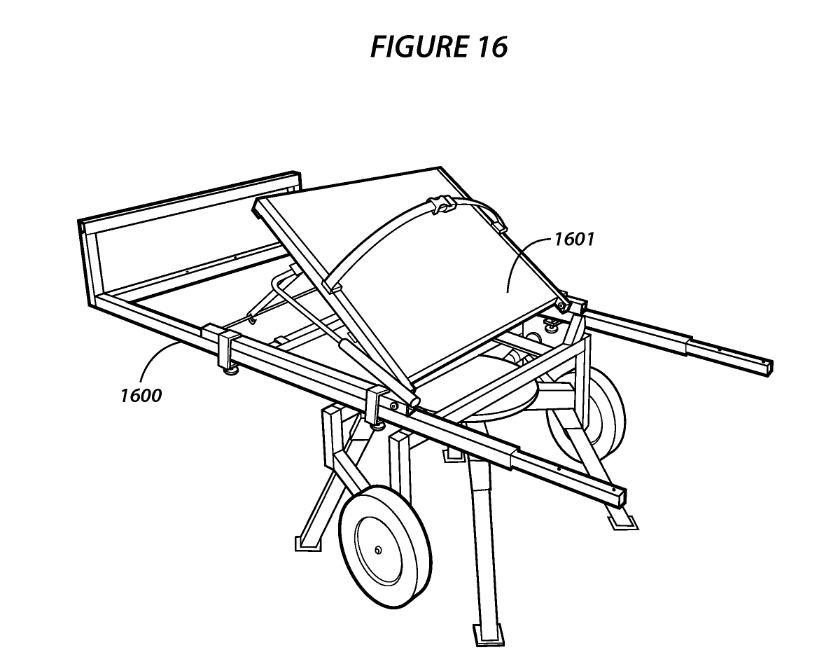

FIG. 16 is an illustration showing the seating attachment 1651 in an inclined position connected to the frame 1601 according to some embodiments of the present disclosure. The seating attachment 1651 is shown in the inclined position.

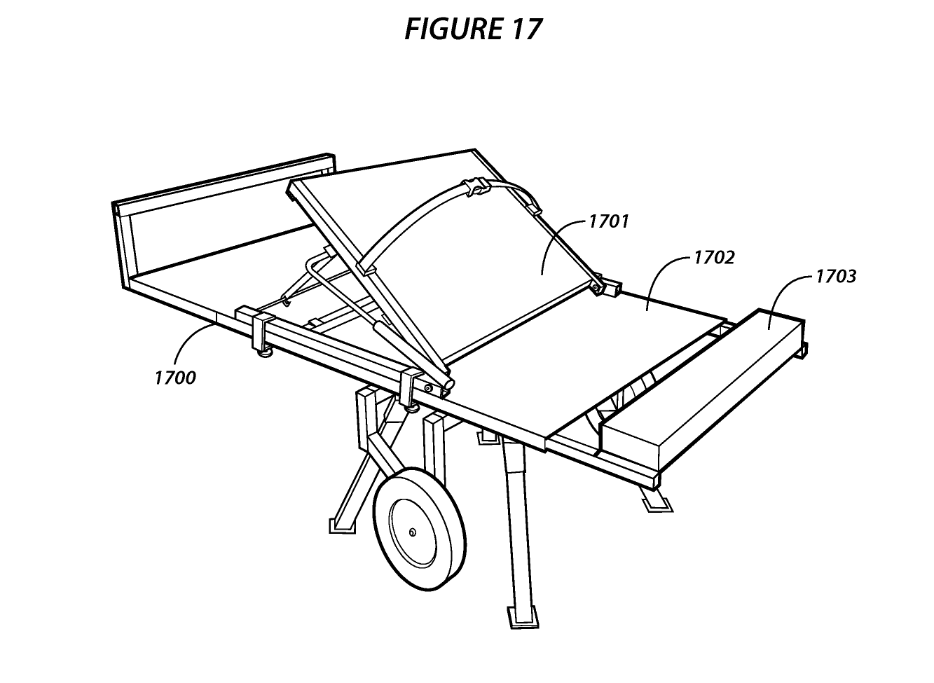

FIG. 17 shows the reclining/inclining seating attachment 1751 in the inclined position connected to the platform assembly's frame 1701. The frame 1701 is shown to be covered with a fabric cover 1761 to support the user's weight in a seated position. The rear frame assembly and footpad 1773 are in the retracted position to allow the user's legs to bend at the knees while sitting in the seating attachment 1751.

It should be understood by one having ordinary skill in the art that a user may sit in the platform assembly configured as shown in FIG. 17 to relax or hunt. Accordingly, the present disclosure provides an apparatus which allows a user to hunt while being concealed, or alternatively, provide a mechanism for a user to be exposed while hunting to allow a greater degree of movement.

Furthermore, the user is able to rotate the frame and the seating attachment 1751 by using his/her feet to push against the surface. A user may rotate the frame 1701 when the seating attachment is in both reclined and inclined positions.

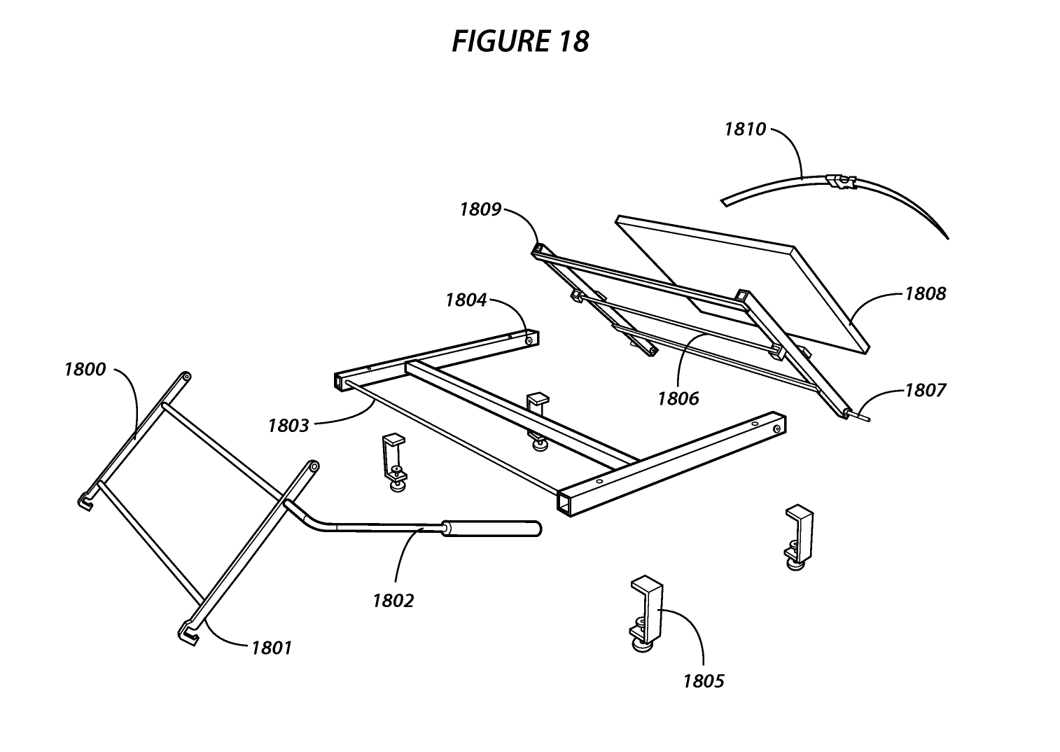

FIG. 18 is an illustration showing the components of a seating attachment 1851 according to some embodiments of the present disclosure. The seating attachment 1851 is achieved using a backrest that pivots on the attachment's frame. The attachment's backrest 1808 is connected across a user's chest using adjustable chest strap 1810. The chest strap 1810 allows the user to incline or recline the backrest on a pivot point axle 1807 connected to the backrest frame 1809.

When assembled, the base frame 1804 is connected to the platform assembly's frame using four screw-tightening clamps 1805. The clamps 1805 are able to attach the seating attachment 1851 anywhere along the platform assembly's middle frame assembly to accommodate users of various sizes.

In addition, swing-arms 1820 are connected to the backrest frame 1809 along a horizontal bar 1806 allowing the bars to rotate freely. The swing-arms 1820 have hooking ends 1821 that when the seating attachment is inclined, are pulled along a horizontal locking bar 1803 by the inclining backrest frame 1809 and lock in place when the hooking ends 1821 reach the horizontal locking bar 1803.

An inclined position release lever 1802 may be operated by the user to push back the swing-arms 1820 and disengage the hooking ends 1821 from the horizontal locking bar 1803. Advantageously, the aforementioned procedure enables the user to recline the backrest and backrest frame to the fixed, reclined position.

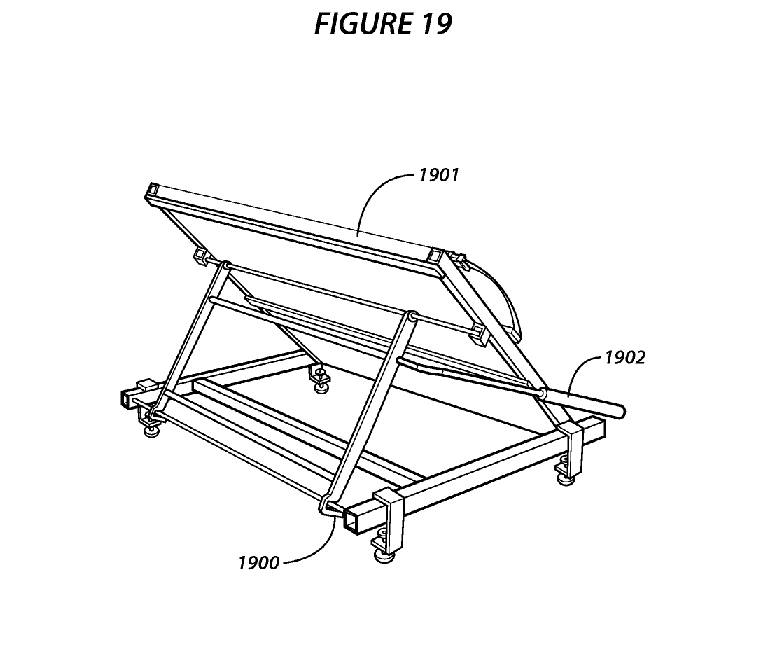

FIG. 19 is an illustration showing a rear-view of the seating attachment in a locked, inclined position according to some embodiments of the present disclosure. The swing-arms 1920 and hooking ends 1921 are shown locked in position. When backrest 1908 is in an inclined position, pressure may be applied to the swing-arms 1920 by the release lever 1902 which will disengage the backrest 1908 from the locked position.

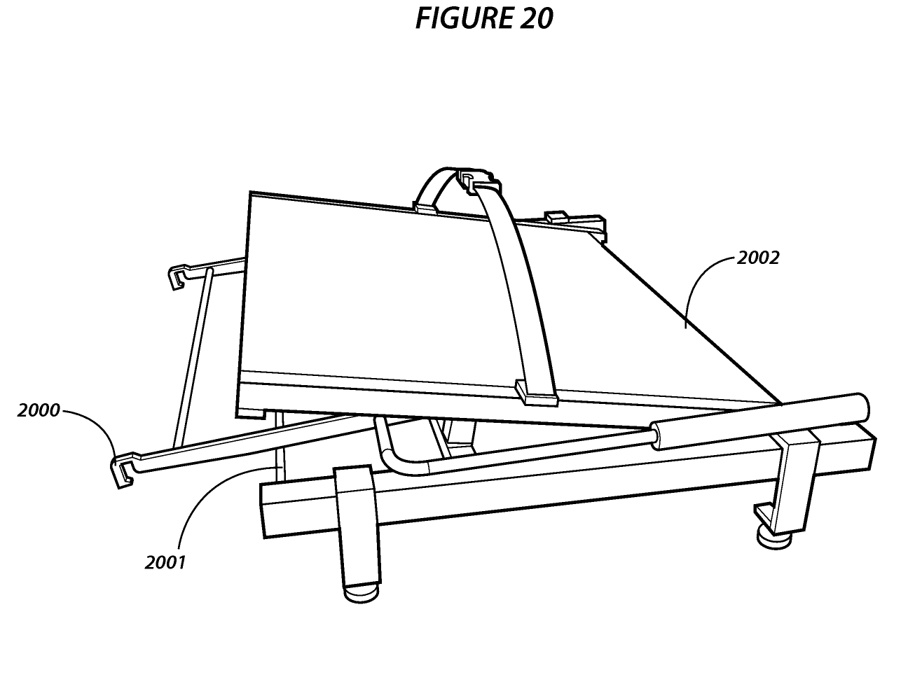

FIG. 20 is an illustration showing the seating attachment in an unlocked, reclined position according to some embodiments of the present disclosure. As shown, the hooking ends 2021 are disengaged from the horizontal locking bar 2003 which enables the backrest frame (not shown) and backrest 2008 to recline from an incline position to a reclined position.

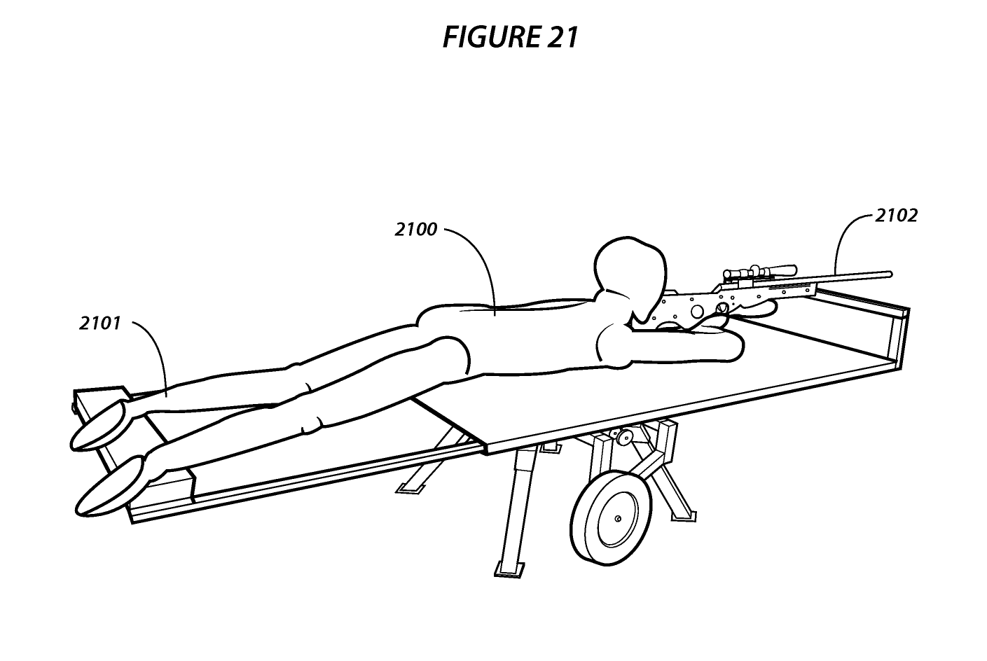

FIG. 21 is an illustration of a person lying on the shooting platform 2140 in the prone position with his/her legs utilizing the footpad 2101 according to some embodiments of the present disclosure. The person's firearm is extended forward while resting on the platform assembly's gun rest 2100. The person's legs and feet are shown extended and resting upon the platform assembly's footpad 2101.

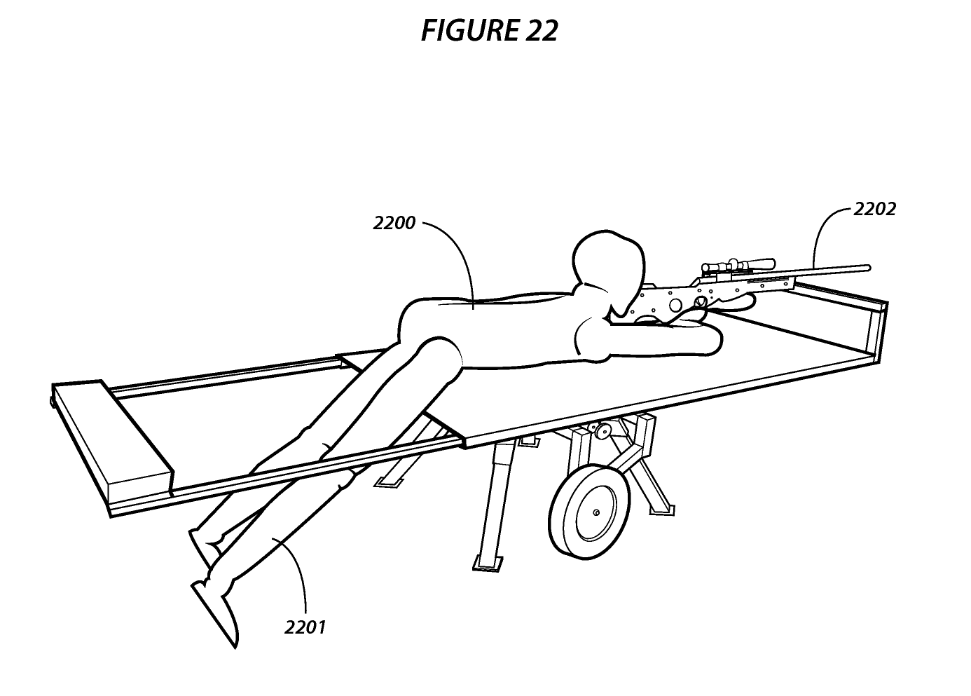

FIG. 22 is an illustration of a person using the platform assembly from the prone position with his/her legs positioned on the ground below according to some embodiments of the present disclosure. The person's firearm is extended forward while resting on the platform assembly's gun rest 2200. In this illustration, the person's legs and are positioned on the surface below. The user is thus able to utilize his/her feet to rotate the frame of the platform assembly while remaining in a prone upper body position. This position enables the user to scan for aiming points in the distance or to follow a moving target using the platform assembly's rotation capability.

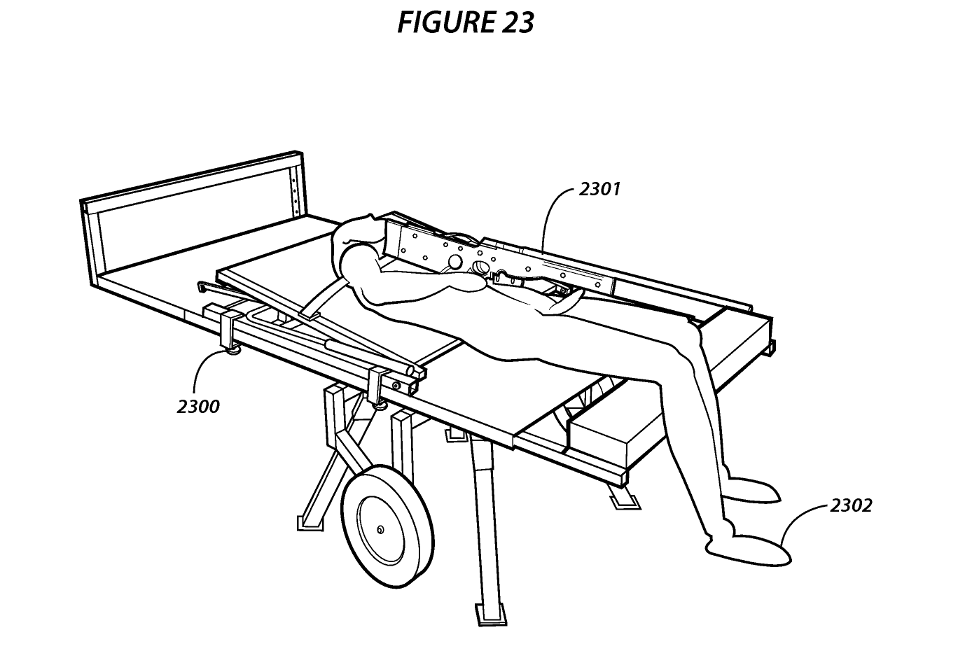

FIG. 23 is an illustration of a person in a reclined position with his/her feet on a surface according to some embodiments of the present disclosure. The person's back is shown resting against the seating attachment's 2315 with the chest strap 2310 is affixed across the user's chest. Furthermore, the person's feet are extended to the surface below enabling the user to rotate the platform assembly and scan the sky above for targets.

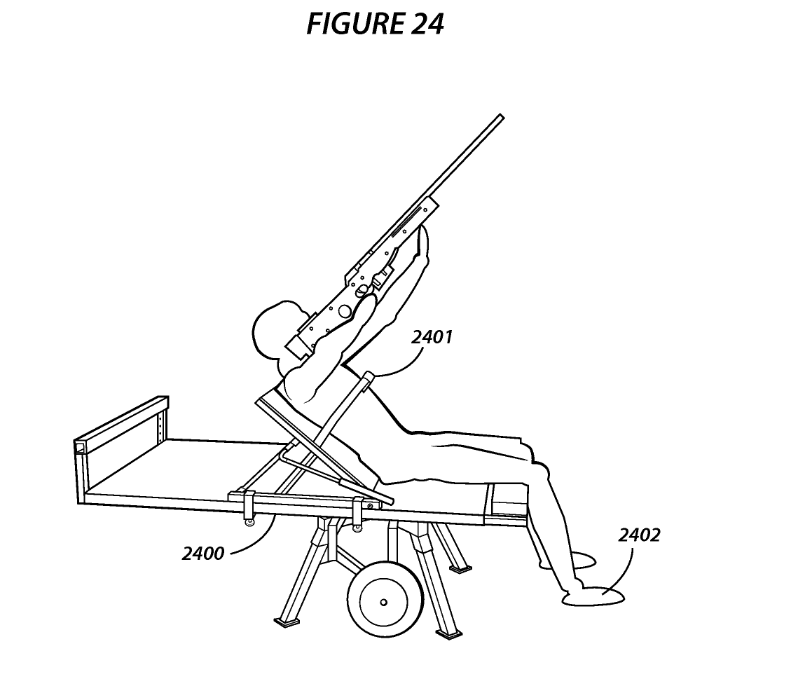

FIG. 24 is an illustration of a person using the platform assembly with the seating attachment 2415 connected to the frame according to some embodiments of the present disclosure. The person's back is shown resting against the seating attachment's 2415 and the chest strap 2410 is affixed across the user's chest. The chest strap 2410 pulls the seating attachment's back pad and frame to the inclined position, locking in place, when the user moves his upper body into a seated position. The person's feet are extended to the ground below enabling the user to rotate the platform assembly to scan for targets.

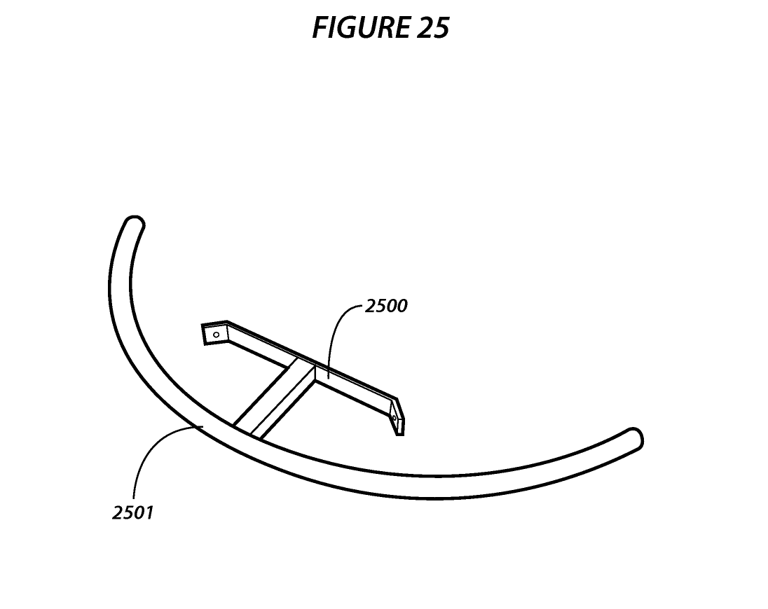

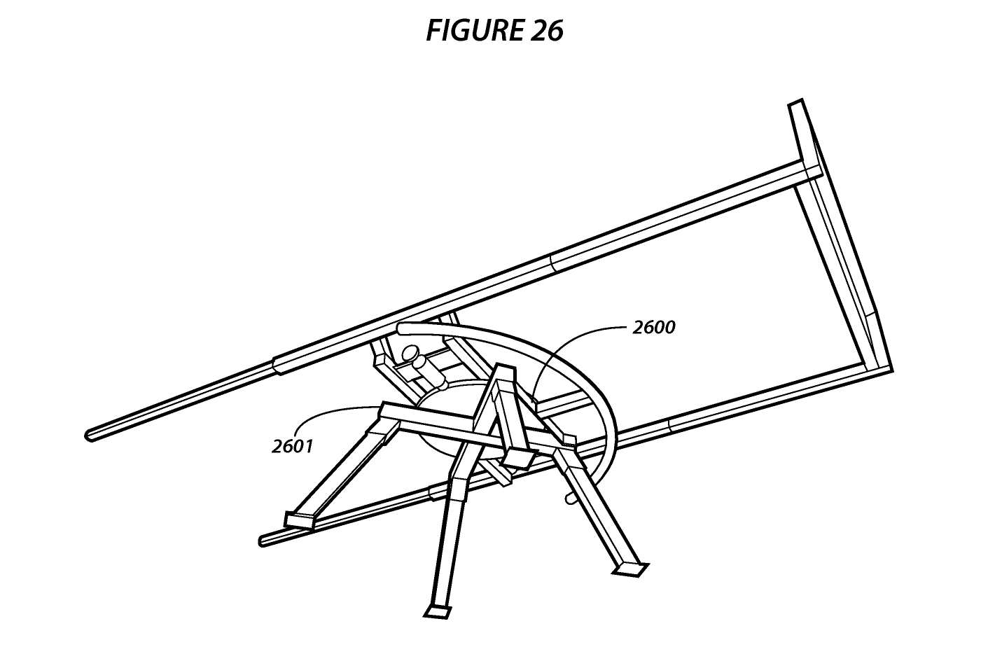

FIG. 25 is an illustration of the platform assembly's handrail attachment 2525 according to some embodiments of the present disclosure. As shown, the handrail attachment 2525 comprises the mounting bracket 2500 and the handrail 2501. FIG. 26 is an illustration of the platform assembly's handrail 2601 attached to the base 2602 according to some embodiments of the present disclosure.

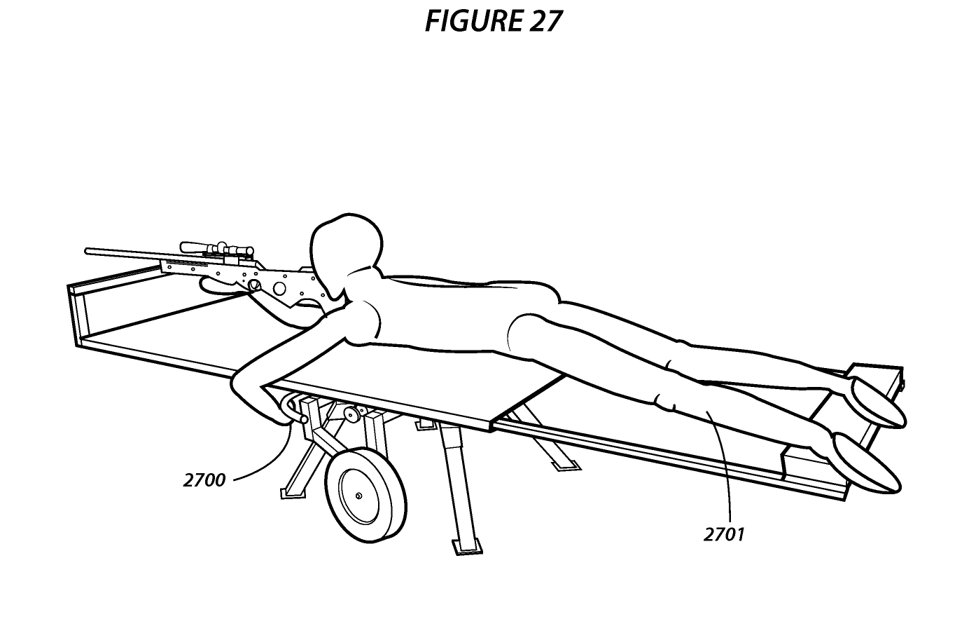

FIG. 27 is an illustration of a user holding onto the handrail 2700 to rotate the platform assembly's frame according to some embodiments of the present disclosure. The platform assembly's frame may also be covered with a full-length fabric cover 2701 if the user does not desire or may not use his/her legs to cause the platform assembly to rotate.

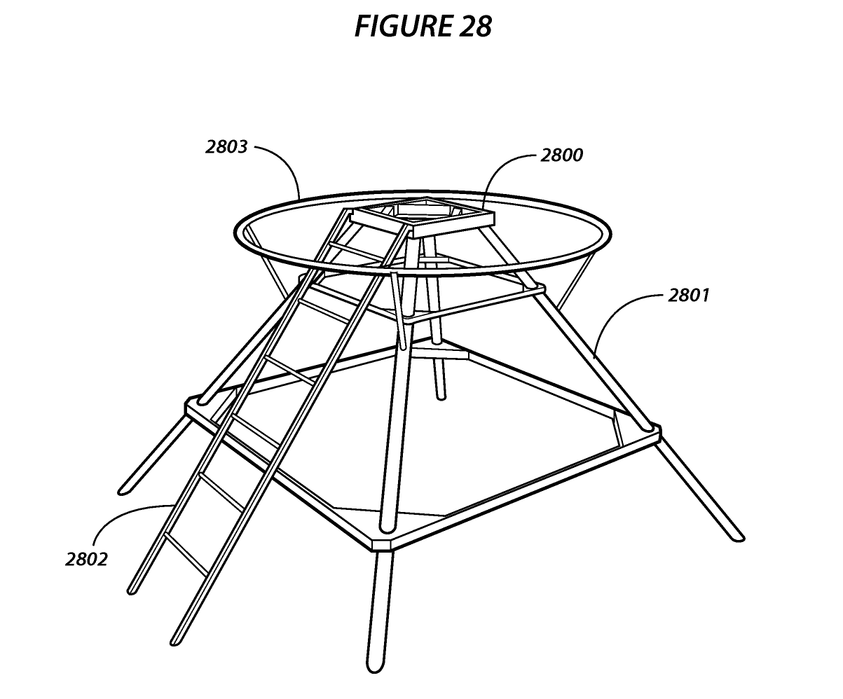

The platform assembly may also be mounted on top of an elevated platform using an extended tripod or quad-pod assembly. FIG. 28 shows an elevated quad-pod platform 2800 without the platform assembly's frame attached. The quad-pod platform 280 comprises a base 2804 on which the platform assembly's frame is attached, extended legs 2801, a ladder 2802, and foot-rail assembly 2803 that is attached around the perimeter of the quad-pod platform 2800. The foot-rail assembly 2803 may be attached higher or lower on the quad-pod assembly 2800 to accommodate users of varying heights and leg lengths.

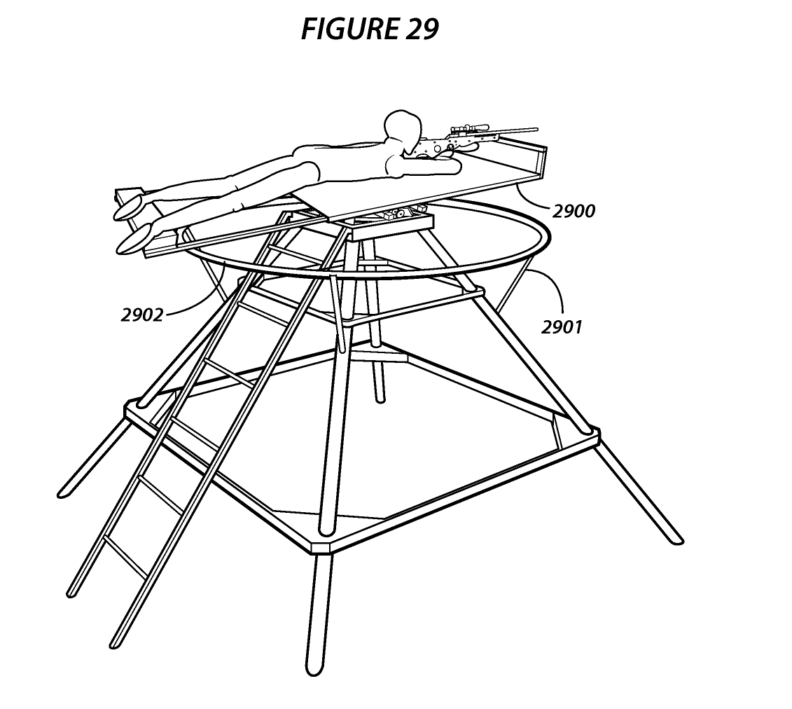

FIG. 29 shows the platform assembly 2900 coupled to the quad-pod platform 2901. As shown, a user is lying on top of the shooting platform 29092 with one foot resting on the foot rest while the other foot is supported by the foot-rail assembly 2904. Advantageously, the user may rotate the platform assembly around a quad-pod platform 2901. Alternatively, the user may rotate the platform assembly by using the handrail attachment (not shown) as the shooting platform is mounted to a tripod or quad-pod assembly.

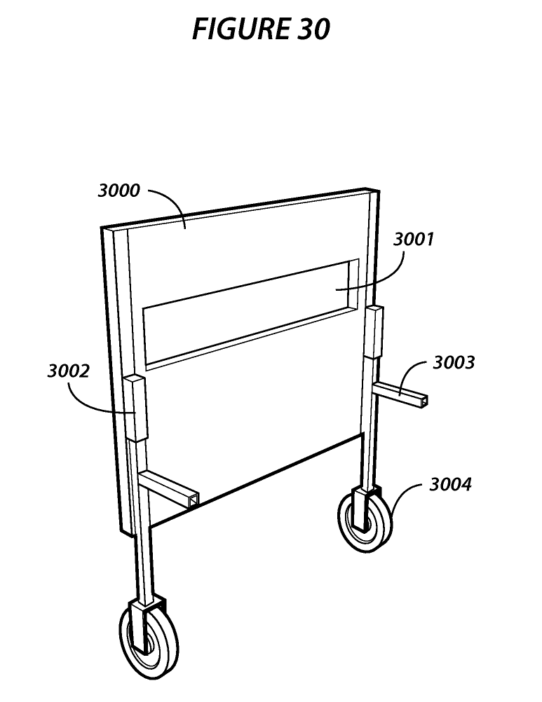

FIG. 30 shows an illustration of a ballistic shield attachment 3000 that may be connected to the platform assembly's frame. The ballistic shield attachment 3000 comprises a ballistic panel 3001 capable of deflecting ballistic projectiles.

In some embodiments, an opening 3002 is in the ballistic panel 3001 for viewing and/or firing a firearm therefrom. The ballistic shield attachment 3000 may include an adjustment rail 3003 that connects the ballistic panel 3001 to the attachment frame of the platform assembly and allows the ballistic panel to be lowered or raised to accommodate users of different sizes. Frame inserts 3003 may be used to connect to the platform assembly's frame. In addition, wheels 3005 may be added to the ballistic shield attachment 3000.

The ballistic shield attachment's wheels 3005 serve two purposes; they allow the platform assembly to be easily moved, and they prevent the platform assembly from tipping over in a forward direction due to the added weight of the ballistic panel. The wheels 3005 are elevated slightly higher than the ground as to not interfere with the rotation of the platform assembly's frame.

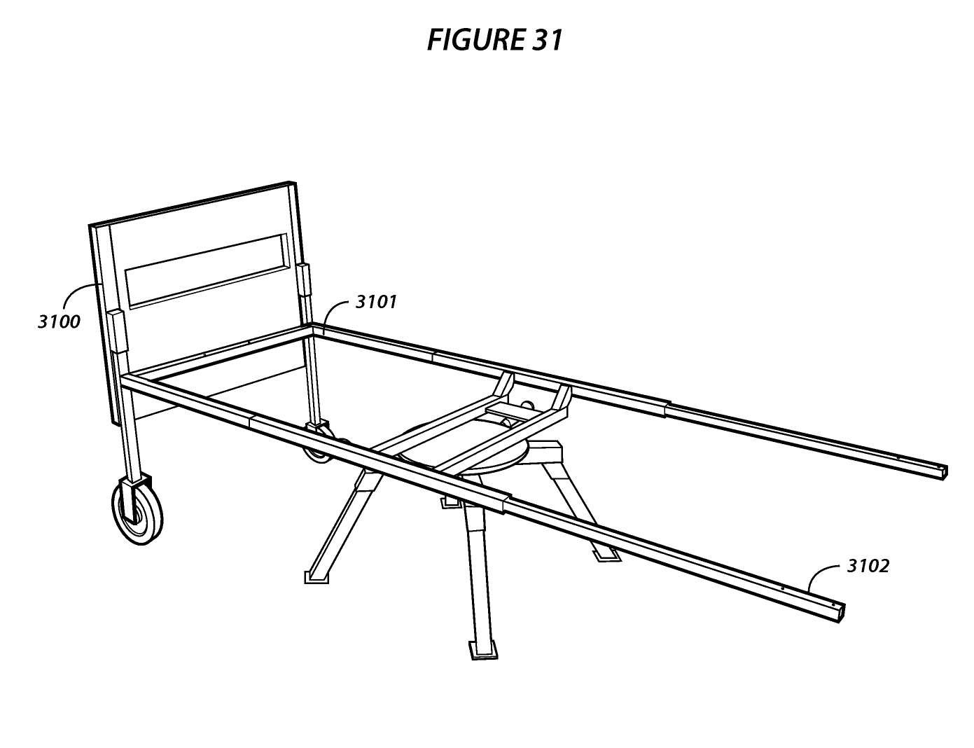

FIG. 31 shows the ballistic shield attachment 3100 connected to the platform assembly's frame 3101. The platform assembly 3115 may be moved with the ballistic shield attachment connected by raising the rear rails 3102 and moving the platform assembly 3115 forward in a similar fashion in which a wheelbarrow is used. Because the ballistic shield attachment 3100 is connected to the platform assembly's frame, the ballistic shield attachment rotates along with the frame.

Systems and apparatuses for hunting, law enforcement, and military have been described. It will be understood that the descriptions of some embodiments of the present disclosure do not limit the various alternative, modified and equivalent embodiments which may be included within the spirit and scope of the present disclosure as defined by the appended claims. Furthermore, in the detailed description above, numerous specific details are set forth to provide an understanding of various embodiments of the present disclosure. However, some embodiments of the present disclosure may be practiced without these specific details. In other instances, well known methods, procedures, and components have not been described in detail so as not to unnecessarily obscure aspects of the present embodiments.

What is claimed is:

1. A hunting apparatus, comprising:
a base; and
a frame coupled to the base;
wherein said base is rotatable around said base;
wherein said base provides concealment for a user therein.
